(19) United States
(12) Patent Application Publication
(10) Pub. No.: US 2012/0206500 A1
(43) Pub. Date: Aug. 16, 2012

(54) VIDEO DATA DEPENDENT ADJUSTMENT OF DISPLAY DRIVE

(75) Inventors: Brion C. Koprowski, Longmont, CO (US); Cory Pecinovsky, Longmont, CO (US)

(73) Assignee: MICRON TECHNOLOGY, INC., Boise, ID (US)

(21) Appl. No.: 13/027,994

(22) Filed: Feb. 15, 2011

(51) Int. Cl. G09G 3/36; G09G 5/10

(52) U.S. Cl. 345/690; 345/87

(57) ABSTRACT

Devices and methods are disclosed for improving image quality in a display system. The devices and methods adjust the display optical states based on the input image data. The devices and methods may compensate for temporal variation of the optical states in a display panel arrangement having a liquid crystal and an insulating layer due to a net DC field across the liquid crystal. The variation in optical states may be variation between the position of the optic axis of the liquid crystal for a zero net DC field drive waveform and a drive waveform with a net DC field across the liquid crystal. The variation of the optic axis of the liquid crystal may be due to ionic charge movement through the liquid crystal. The display panel arrangement may have a decay time constant of the liquid crystal and the insulating layer less than a maximum time that is visually acceptable for image sticking to persist on the display panel.

### FIELD OF THE INVENTION

Embodiments of the present invention relate generally to electronic display systems, and more particularly to improving image quality and optical performance in electronic display systems.

### BACKGROUND

Electronic display systems are increasing prevalent in today's society. Common electronic displays include computer monitors, laptop displays, televisions, and projector systems. Additionally, a broad range of multi-function products have at least one electronic display including, for example, hand-held devices, tablet computers, cell-phones, smart-phones, digital still cameras, and camcorders. For all of these types of electronic displays, manufacturers strive to improve the image quality of their displays to make them easier to use under a wide variety of viewing conditions and provide a better overall viewing experience. Improvements in image quality include increasing color depth, brightness, and display contrast ratio. These improvements also include reducing display artifacts such as “image sticking,” motion artifacts, or color artifacts.

A variety of display technologies are available to make electronic displays, including but not limited to liquid crystal displays (LCDs), organic light-emitting diode displays (OLEDs), plasma displays (PDPs), and displays based on micro-electro-mechanical system (MEMS) technology. These technologies typically use an array of pixel electrodes to drive a voltage or a current to a material or a device that either allows light to be transmitted, reflected, or emitted. These display technologies may suffer from a variety of limitations in performance. For example, it may be difficult to achieve a full range of optical states from a pitch-black dark state to high brightness in a bright state. Another problem that may affect various types of displays is “image sticking,” caused by hysteresis in the optical output of the display. The result is an objectionable “ghost” image that persists after the image is changed on the display.

To illustrate how display performance may be limited in a particular technology, a basic understanding of liquid crystal displays is provided, however, it will be appreciated that other display technologies may suffer from similar limitations in performance.

Liquid crystal displays typically drive an electric field across a liquid crystal layer using a pixel electrode and a common electrode. The liquid crystal layer changes the polarization of light passing through the display by way of the director or optic axis of the liquid crystal molecules. When combined with polarizing filters, this effect produces the ability to modulate light. By way of illustration, a transmissive liquid crystal display may have a layer of liquid crystal between crossed polarizing filters. The liquid crystal layer may be designed such that the optic axis of the layer is aligned with a first polarizing filter, generally called the “polarizer,” when no voltage is applied. In this state, light from the polarizer passes through the display with its polarization unchanged and is extinguished by the orthogonal second polarizer, generally called the “analyzer.” This produces a dark state. If an applied voltage field across the liquid crystal layer effectively rotates the optic axis such that light passing through the polarizer is rotated to be in alignment with the analyzer it will be transmitted, producing a bright state. Reflective liquid crystal displays operate in a similar manner but they typically have only one polarizing filter or a polarizing beam splitter that effectively operates as both the polarizer and analyzer.

Grayscale may be generated by modulating the voltage field across the liquid crystal layer to adjust the optic axis in-between a dark state and a bright state to produce an intermediate state corresponding to the desired grayscale. Alternately, pulse width modulation (PWM) may be used to drive the liquid crystal to a bright state for a time period proportional to the desired brightness intensity level. Because the viewer's eye is not fast enough to perceive the PWM waveform of the pixel, the viewer will see a light output level corresponding to the desired brightness intensity level.

To produce full-color images, color filters may be added in a sub-pixel structure, where each sub-pixel typically displays one of the red, green, or blue component image colors. Alternately, a field sequential color operating mode may be used. In this mode, the red, green, and blue component color images are shown in succession, synchronously illuminated with corresponding red, green, and blue light. When these component images are displayed quickly, typically at a higher rate than a standard video frame rate, viewers perceive a full-color image instead of the individual component images. For field sequential color displays, a ferroelectric liquid crystal may be preferred because of its high switching speed. Because ferroelectric liquid crystals (FLCs) tend to prefer to switch to one of two optical states, PWM is generally used with FLCs to create gray scale for each component color. The two optical states are generally selected in FLCs by driving positive and negative voltage fields across the FLC.

Liquid crystal displays may have limitations with regard to the range of optical states that the liquid crystal layer can produce. The range of optical states produced by a liquid crystal display is determined by several factors including the amount which the liquid crystal layer can rotate incoming polarized light. In some liquid crystals this may be determined by a twist in the optic axis through the liquid crystal layer. In FLCs, the range of optical states is determined by an optic axis rotation angle over which the liquid crystal molecules can rotate with respect to the plane of the liquid crystal layer surface. To produce a fully transmissive bright state and fully extinguishing dark state the optic axis rotation angle must be sufficient to rotate light passing through the display in a dark state to be completely orthogonal to the analyzer and in a bright state to be completely parallel to the analyzer.

For a variety of reasons, a liquid crystal layer may not be able to produce a fully transmissive bright state and fully extinguishing dark state. For example, an FLC may have a native limitation in the optic axis rotation angle between the effective optic axis of the bright state and the effective optic axis of the dark state. While increasing the drive voltage tends to increase the optic axis rotation angle, the FLC may be damaged if the voltage is increased beyond some threshold. Additionally, increasing drive voltage potentially requires larger circuits or a more expensive manufacturing process, either of which may be prohibitively expensive.

Liquid crystal displays may also suffer from “image sticking.” In particular, one type of image sticking is believed to be caused by accumulation of charge at the surfaces of the liquid crystal layer in response to applied voltages. The accumulated charge modifies the voltage field across the liquid crystal layer even after the applied voltage is removed or reversed. The result is a residual “ghost” image that persists after the display image has changed and may decay according to a decay time constant in the range of minutes to hours. In general, this type of image sticking may be reduced by ensuring that the time-averaged electric field across the liquid crystal layer is zero, or “DC balanced.” For some types of liquid crystal displays, including ferroelectric liquid crystals, this may require that the inverse or complement of the image be displayed during a period where the display is not illuminated to ensure that the electric field across the liquid crystal layer is DC balanced. However, time periods where the display is not illuminated reduce the overall brightness of the display. Therefore, reducing or eliminating image sticking without decreasing the brightness of liquid crystal displays has traditionally been an unattainable goal for display manufacturers.

The foregoing examples of display technology and the related limitations are intended to be illustrative and not exclusive. Against this background and with a desire to improve on the prior art, embodiments of the present invention have been developed.

### BRIEF DESCRIPTION OF THE DRAWINGS

Embodiments of the present invention are illustrated in referenced figures of the drawings. It is intended that the embodiments and figures disclosed herein be considered illustrative rather than limiting.

FIG. 1 is a diagrammatic view of a reflective display system.

FIG. 2 illustrates a liquid crystal display.

FIG. 3 shows a cross-section of a liquid crystal cell.

FIG. 4 shows example pulse width modulated pixel drive waveforms.

FIG. 5 illustrates the optic axis rotation range of a ferroelectric liquid crystal cell.

FIG. 6 illustrates adjustment of the optic axis rotation range of a ferroelectric liquid crystal cell.

FIG. 7 is a graph showing normalized optical transmission for dynamic adjusted optic axis rotation ranges.

FIG. 8 shows a simplified circuit of a ferroelectric liquid crystal cell with alignment layers.

FIG. 9 shows a further simplified equivalent circuit of a ferroelectric liquid crystal cell with alignment layers.

FIG. 10a illustrates pulse width modulated drive waveforms applied to a ferroelectric liquid crystal cell with duty cycles ranging from 10% to 90%.

FIG. 10b illustrates the voltage field across the ferroelectric liquid crystal layer in a ferroelectric liquid crystal cell with an insulating layer, corresponding to the drive waveforms of FIG. 10a.

FIG. 11a is a graph of bright state and dark state optic axis orientations versus drive waveform duty cycle for ferroelectric cells with and without added ionic conductivity.

FIG. 11b is a graph of optic axis rotation range versus drive waveform duty cycle for ferroelectric cells with and without added ionic conductivity.

FIG. 12 is a timing diagram showing example pixel drive waveforms for a ferroelectric liquid crystal layer.

FIG. 13 illustrates the optic axis rotation range for a ferroelectric liquid crystal, driven according to the drive waveforms of FIG. 12.

FIG. 14 is a graph showing normalized optical transmission for dynamic adjusted optic axis rotation ranges.

FIG. 15 is a timing diagram showing example pixel drive waveforms and video data dependent adjustment of the common window voltage.

FIG. 16 is a timing diagram showing example pixel drive waveforms and video data dependent adjustment of the common window voltage.

FIG. 17a is a graph of transfer functions between a characteristic of an input image related to image brightness and drive field adjustments.

FIG. 17b illustrates a comparison of bright state performance for a ferroelectric liquid crystal display.

FIG. 18a shows a graph of a characteristic of image brightness over time.

FIG. 18b shows example window step voltages over time resulting from a transfer function of a characteristic of image brightness.

FIG. 19 is a block diagram of a microdisplay panel.

### DETAILED DESCRIPTION OF EXEMPLARY EMBODIMENTS

Reference will now be made to the accompanying drawings, which assist in illustrating the various pertinent features of embodiments of the present invention. Although embodiments of the present invention will now be described primarily in conjunction with a reflective ferroelectric liquid crystal (FLC) microdisplay, it should be expressly understood that the present invention may be applicable to other liquid crystal display technologies including nematic liquid crystal displays and other display technologies such as plasma display panels (PDPs), micro-electro-mechanical system (MEMS) displays, organic LED (OLED) display panels and microdisplays and/or to other applications where it is desired to increase display brightness and display contrast ratio and reduce objectionable display artifacts. In this regard, the following description of a reflective FLC microdisplay is presented for purposes of illustration and description. Furthermore, the description is not intended to limit the invention to the form disclosed herein. Consequently, variations and modifications commensurate with the following teachings, and skill and knowledge of the relevant art, are within the scope of embodiments of the present invention. The embodiments described herein are further intended to explain and to enable others skilled in the art to utilize the described embodiments, or other embodiments with various modifications required by particular application(s) or use(s) of embodiments of the present invention.

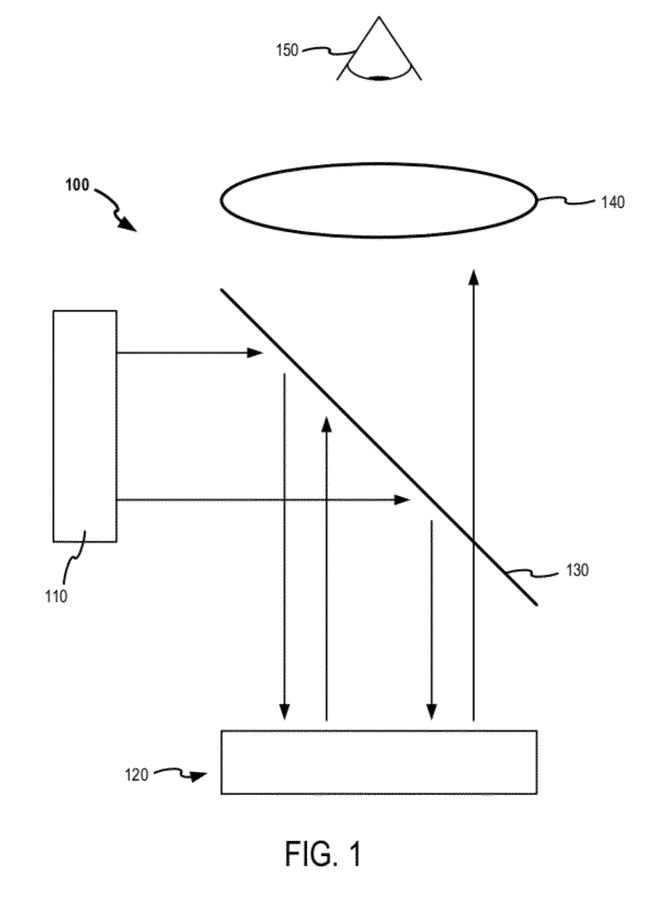

FIG. 1 illustrates a reflective microdisplay system 100 according to embodiments of the present invention. The reflective microdisplay system 100 may include an illumination source 110, reflective microdisplay panel 120, polarizing beam splitter 130, and lens system 140. Reflective microdisplay system 100 may be a near-to-eye system where a viewer 150 looks into lens system 140 to view the displayed image, or a projection system, where the displayed image is projected onto an external surface by lens system 140.

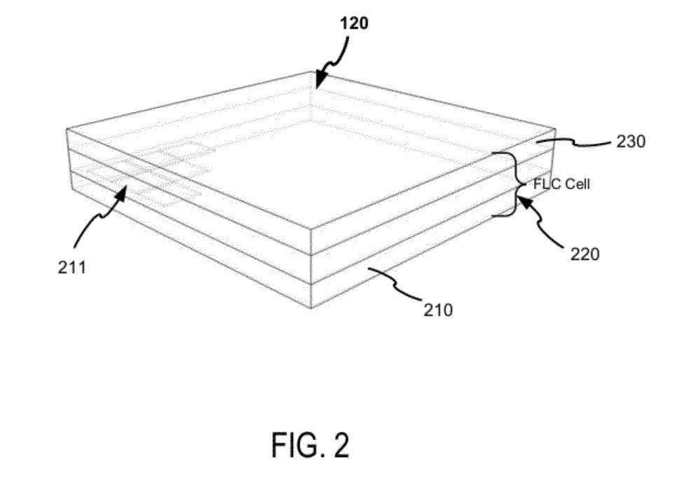

Reflective microdisplay panel 120 may be a reflective liquid crystal microdisplay panel. FIG. 2 illustrates a reflective liquid crystal microdisplay panel 120 according to various embodiments of the invention. Reflective liquid crystal microdisplay panel 120 may be composed of various layers, including substrate 210, an array of pixel electrodes 211 (only a subset of the array of pixel electrodes are shown for clarity) formed on top of or in the plane of substrate 210, window glass layer 230, and a liquid crystal layer between substrate 210 and window glass 230. The various layers that determine the electro-optical properties of the reflective liquid crystal display may be generally referred to as liquid crystal cell 220.

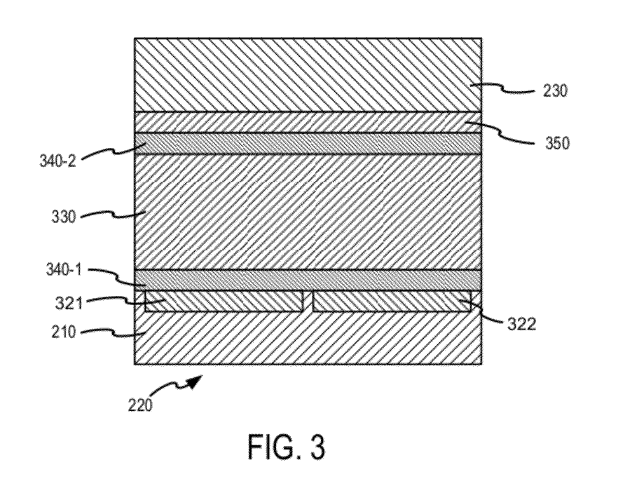

FIG. 3 illustrates the general structure of an example of a liquid crystal cell 220 in more detail. Liquid crystal cell 220 includes liquid crystal layer 330, alignment layers 340-1 and 340-2, common window electrode 350, and window glass 230. The substrate 210 and the window glass 230 generally define parallel surfaces bounding the liquid crystal layer 330, with common window electrode 350 disposed on the inner surface of window glass 230. Liquid crystal cell 220 may include one or more alignment layers 340-1 and 340-2 for creating a desired liquid crystal director or optic axis alignment. Substrate 210 may have an array of pixel electrodes including pixel electrodes 321 and 322, and transistors and other circuit elements fabricated on or within substrate 210 that address pixel circuits, store image data, determine pixel switching, and drive voltages to the array of pixel electrodes.

Liquid crystal layer 330 may be an FLC layer. Like other liquid crystals, FLCs are composed of elongated electric dipole molecules that may prefer to align themselves generally parallel to each other in one direction, called the director or optic axis of the FLC. When FLCs are placed within parallel substrates, the FLC may form parallel layers of molecules, where the boundaries of each layer are defined by the ends of the FLC molecules. The layers may be oriented within the parallel substrates such that the plane of the layers is orthogonal to the plane of the substrates. The angle of the FLC director relative to the layer normal may be constrained by the molecular properties of the FLC mixture and composition and surface treatment of alignment layers. This angle is generally known as the tilt angle. An electric field applied to the FLC layer applies a torque to the electric dipole of the FLC molecules, allowing the molecules to be rotated around a cone with the layer normal as the axis and conic angle defined by the tilt angle. In this way, the optic axis of the FLC layer may be rotated through positions on the cone surface by applying an electric field across the FLC layer.

FLCs typically exhibit a preference for the FLC molecules to be in one of two more stable states where the director of the FLC is generally parallel to the substrate surface. While these states are more stable than other positions on the FLC cone, there is a degree of analog response in the FLC optic axis position relative to the orientation of the substrate. Therefore, while a positive voltage field across the FLC layer will tend to switch the FLC molecules to one of the two stable states on the cone defined by the tilt angle, the exact optic axis position varies somewhat with applied voltage.

The electric field across the FLC layer is determined by the voltages of the array of pixel electrodes and the common window electrode 350. The pixel electrodes may switch between a low pixel voltage V_{PIXL} and a high pixel voltage V_{PIXH}, while common window electrode 350 is at an intermediate voltage V_{WIN}. For example, V_{PIXL} may be 0V, while V_{PIXH} may be 5V and V_{WIN} may be 2.5V. In this example, when pixel electrode 321 is at V_{PIXL}, FLC layer 330 has an electric field V_{FLCL} of −2.5V from the pixel electrode 321 to the common window electrode 350. When pixel electrode 321 is at V_{PIXH}, FLC layer 330 has an electric field V_{FLCH} of +2.5V from the pixel electrode 321 to the common window electrode 350. The positive and negative electric fields across FLC layer 330 switch the FLC molecules generally from one side of the FLC cone to the other.

As with other liquid crystals, FLCs exhibit optical birefringence, which causes light polarized parallel to the optic axis to experience a different index of refraction than light polarized perpendicular to the optic axis. Light that is polarized parallel to the optic axis will pass through the FLC layer with its polarization direction unchanged. However, light passing through the FLC layer polarized at an angle to the optic axis will have its polarization rotated by phase retardation. If the FLC layer is of an appropriate thickness, the polarization of light passing through the FLC will be rotated by twice the angle (Θ) of the optic axis to the incident light. Combined with a first polarizing filter, or “polarizer,” and a second polarizing filter, or “analyzer,” the FLC layer can modulate light. With a crossed polarizer and analyzer, this creates a dark optical state when the optic axis of the liquid crystal is parallel to the axis of the polarizer and a bright optical state when the optic axis of the liquid crystal is at an angle to the axis of the polarizer. To achieve the brightest possible bright state, the FLC optic axis would be at a 45 degree angle to the polarizer and induce a 90 degree polarization rotation, which would allow the analyzer to fully transmit all light passed through the polarizer. In reflective microdisplay system 100, polarizing beam splitter 130 operates as both the polarizer and the analyzer, creating a crossed polarizer system.

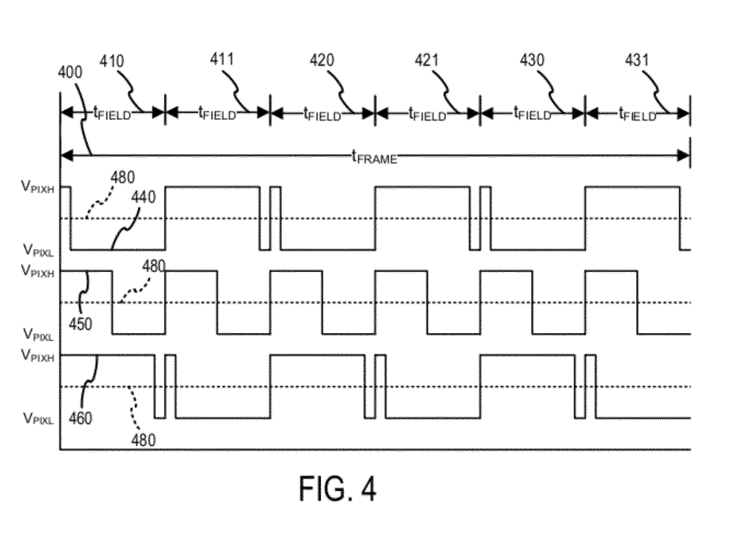

Microdisplay system 100 may display input images received as input image data that are grayscale images or full-color images. Because FLCs are fast-switching liquid crystals and have two primary stable states, grayscale is most commonly generated using pulse width modulation (PWM). Color may be achieved using field sequential color (FSC) or using color filters over sub-pixels for the individual colors. FIG. 4 illustrates example pixel drive waveforms for displaying a full-color input image using FSC to generate color and PWM to generate grayscale. Frame period 400 is split into color field periods 410, 411, 420, 421, 430, and 431. The reflective FLC display may be illuminated with red light during field period 410, green light during field period 420, and blue light during field period 430. Waveform 440 illustrates a 10% brightness level using PWM, while waveform 450 illustrates a 50% brightness level using PWM, and 460 illustrates a 90% brightness level using PWM. The pixel electrodes in waveforms 440, 450, and 460 switch between the high pixel voltage V_{PIXH} and the low pixel voltage V_{PIXL}. The common window electrode is driven to a voltage V_{WIN} in-between V_{PIXH} and V_{PIXLm}, as illustrated by waveforms 480.

FLCs have traditionally required drive waveforms that have a zero time-averaged DC field. During field periods 411, 421, and 431, called balance periods, the pixels may be driven to V_{PIXH} for a time that is complementary to the time that the pixel was driven to V_{PIXH} during the preceding illuminated time period. For example, during balance time period 411, pixel waveform 440 is driven to V_{PIXH} for a time period that is complementary relative to t_{FIELD} of the time period that pixel waveform is driven to V_{PIXH} relative to t_{FIELD} during illumination period 410. This waveform maintains a zero time-averaged DC electric field across the FLC layer over the frame time 400. This drive scheme, called dc-compensation or dc-balancing, prevents charge accumulation at the FLC-alignment layer interfaces.

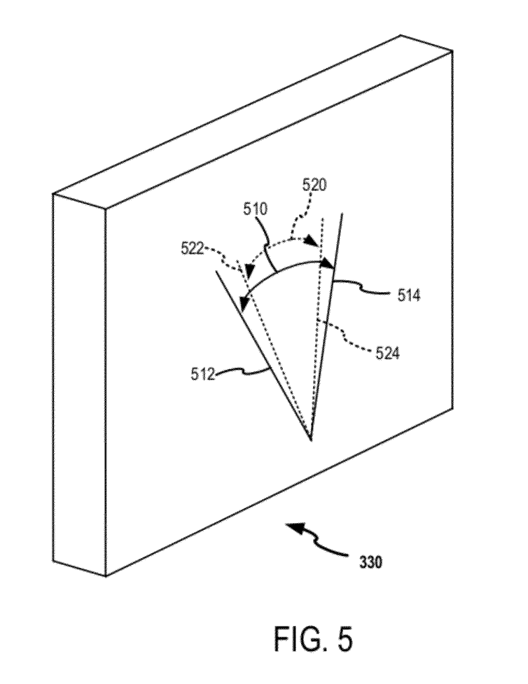

For a variety of reasons, it may not be possible in a particular display panel configuration to rotate the FLC optic axis through a 45 degree angle from the dark state optic axis to the bright state optic axis. For example, the maximum voltage that may be applied to a pixel electrode for a particular display technology may be limited by the breakdown voltage of the transistors used in active pixel drive circuits. This limited voltage range may not switch the optic axis completely through an optimal 45 degree angle with FLC voltage fields V_{FLCL} and V_{FLCH}. FIG. 5 illustrates FLC layer 330 with projections of the primary stable FLC optic axis positions on the FLC cone onto the plane parallel to the panel surface, defining an optic axis rotation range (Δ_{Θ}). Optic axis rotation range 520 between the dark state optic axis 522 and the bright state optic axis 524 is less than optimal 45 degree optic axis rotation range 510. If the polarizer is aligned with axis 512 and the analyzer is crossed to the polarizer, the FLC layer with optic axis rotation range 520 will produce a dark state that is not fully extinguished and a bright state that is not fully transmissive. When FLC layer 330 is switched to have dark state optic axis 522, light polarized along axis 512 will be rotated through FLC layer 330 to an axis that is twice the angle between axis 512 and dark state optic axis 522. Because this rotated light will have a component parallel to the analyzer, it will not be fully extinguished. When FLC layer 330 is switched to have bright state optic axis 524, light passing through the polarizer will be rotated twice the angle between axis 512 and bright state optic axis 524 before reaching the analyzer. Because this light has a component that is orthogonal to the analyzer, it will not be fully transmitted.

As described above, FLC layer 330 may have some analog response to increasing the voltage field across the FLC for the bright state and dark state optic axis positions. However, high pixel voltage V_{PIXH} may be constrained by circuit topology or manufacturing process within a certain voltage range. Within this range, electric fields V_{FLCL}=V_{PIXL}−V_{WIN} and V_{FLCH}=V_{PIXH}−V_{WIN}, where V_{WIN}=½(V_{PIXH}−V_{PIXL}), may not rotate the molecules of FLC layer 330 to the optimal 45 degree optic axis rotation range 510.

Increasing drive voltage requires circuits capable of driving the higher voltage. To manufacture a reflective FLC microdisplay at a small pixel pitch it may be advantageous to use a standard integrated circuit process. The range of voltages available for the standard integrated circuit process may be limited by the technology and size of the transistors in the process. For example, in a 0.25 micron CMOS process, the standard voltage level for which the transistors are designed may be 2.5 V. It may be possible to increase the available voltage range by cascoding transistors, however, multiple levels of cascoded transistors increases circuit complexity and therefore circuit and pixel size. It may also be possible to use special transistors of higher voltage for pixel circuits, however, this also increases either circuit and pixel size, or increases processing cost by adding special processing steps, or both. Therefore, increasing pixel voltage will likely increase pixel pitch or manufacturing process cost, which both increase the final cost of the microdisplay panel. Increasing the applied voltage beyond a certain point may also damage the liquid crystal if the increased voltage is constantly applied.

The general solution to an FLC layer with a reduced optic axis rotation range is to rotate optic axis rotation range 520 so that the dark state optic axis is aligned with the polarizer along axis 512. This will produce a fully extinguished dark state. A fully extinguished dark state is important because the contrast ratio of a display is the ratio of the optical throughput of the bright state to the optical throughput of the dark state. Because the dark state is the denominator in the contrast ratio, making the dark state darker by a certain amount has a much larger impact on display contrast than increasing the bright state by the same amount. However, aligning the dark state optic axis of optic axis rotation range 520 with the polarizer axis 512 reduces the maximum brightness of the display further as bright state optic axis 524 will also be rotated towards axis 512, reducing optical throughput in the bright state.

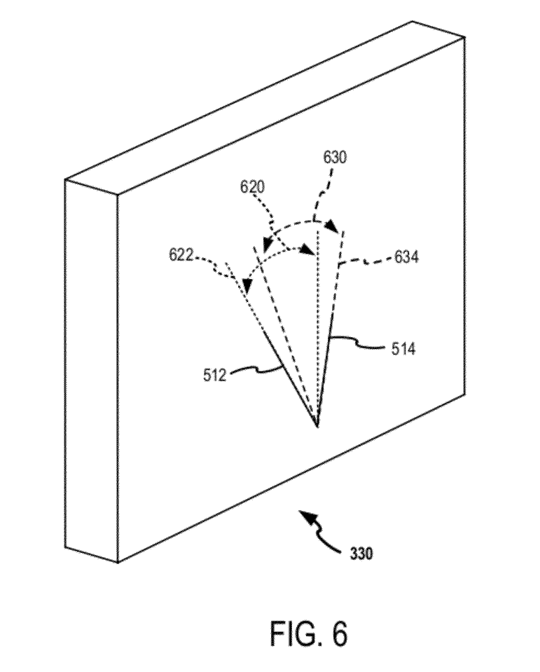

With these problems in mind, video data dependent adjustment of display drive for modifying the optic axis rotation range to improve the optical performance of FLC layer 330 will be described. FIG. 6 illustrates an FLC layer where the optical states of the FLC are rotated by adjusting the display drive depending on the input image data. If the input image data is substantially dark, the display drive fields are adjusted such that the dark state optic axis 622 is aligned with polarizer axis 512 and the FLC layer has optic axis rotation range 620. This produces an improved dark state and higher display contrast ratio but reduces brightness for substantially dark images. A substantially dark image is the input image brightness level below which it is desired that the light output in the dark state is minimized. For example, a substantially dark image could be an input image where the average of the image data values is less than 5% of maximum brightness. If the input image data is substantially bright, the drive fields are adjusted such that the bright state optic axis of the FLC layer is moved towards or aligned with a 45 degree angle to polarizer axis 512, illustrated by optic axis rotation range 630. This produces higher optical throughput in the bright state but more light throughput in the dark state. A substantially bright image is the input image brightness level above which maximum brightness of the bright state is desired. For example, a substantially bright image could be an input image where the average of the image data values is greater than 95% of maximum brightness. For input image brightness levels in between a substantially dark image and a substantially bright image, the display drive field may be adjusted to rotate the optic axis rotation range to an intermediate position. Although 5% brightness and 95% brightness are used as examples of substantially dark and bright images, other suitable values could be used, such as 10% and 90%, 20% and 80%, and so forth. Furthermore, the values do not have to be mirror images of one another, for example, a substantially dark image may be an image of less than 25% brightness while a substantially bright image is one above 85% brightness.

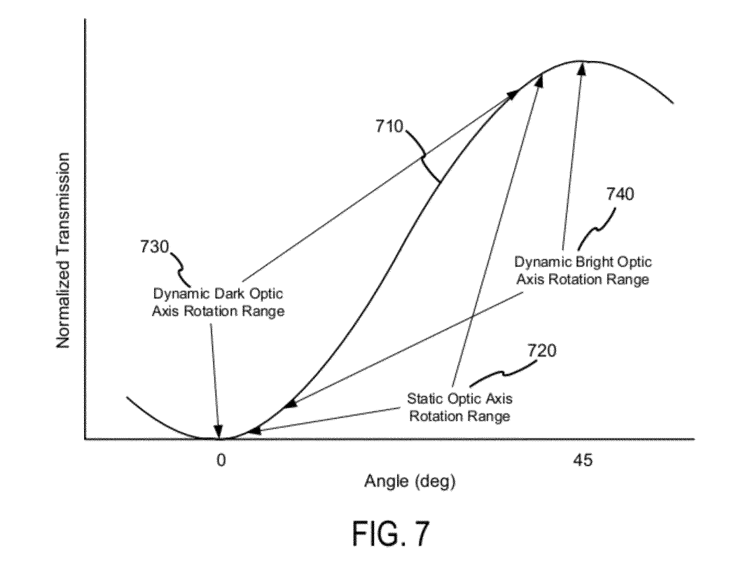

FIG. 7 illustrates the advantages of video data dependent adjustment of display drive with regard to optical throughput of the display panel. Normalized optical transmission curve 710 depicts the relationship between optical throughput and optic axis angle relative to polarizer axis 512. For an FLC layer where polarized light is rotated by twice the incident angle (Θ) between the polarizer and the optic axis, curve 710 describes the optical transmission according to the equation T=sin² (2Θ). Points on curve 710 described by static optic axis rotation range 720 show the optical states for an optic axis rotation range of approximately 38 degrees. Using video data dependent adjustment of display drive, the optical states are dynamically rotated for a substantially dark image to dynamic dark optic axis rotation range 730, producing a fully extinguished dark state. For a substantially bright image, the optical states are dynamically rotated to dynamic bright optic axis rotation range 740, producing a brighter and possibly fully transmissive bright state.

The video data dependent adjustment of display drive takes advantage of the response of the viewer's eye to the overall brightness of a particular image. For a substantially dark image, a reduced bright state may not be apparent to the viewer because the viewer's eye will adjust to the overall brightness of the image, making the bright portions of a substantially dark image look brighter. For a substantially bright image, the viewer's eye adjusts to the brightness of the image and it will be harder for the viewer to perceive that dark portions of the image have become brighter. For example, a fully dark-adapted eye may have a sensitivity threshold to grayscale levels several orders of magnitude lower than an eye adapted to bright conditions. Accordingly, video data dependent adjustment of display drive produces brighter images when higher brightness is most important and darker images when it is more important to produce a darker dark state.

The video data dependent adjustment of display drive may be accomplished by changing the voltage of the common window electrode V_{WIN}. In this embodiment, adjustment of display drive may be independent of pixel drive voltages. For example, PWM waveforms between a high pixel voltage V_{PIXH} and a low pixel voltage V_{PIXL} proportional to the image data values of an input image may be used to generate grayscale during illuminated periods for the array of pixels in a display. The pixel drive waveforms may be dc-compensated by providing non-illuminated balance periods that have inverse PWM waveforms with respect to the illumination periods. For a substantially dark image, V_{WIN} may be increased above ½(V_{PIXH}−V_{PIXL}) during an illumination period, which makes V_{PIXL} a more negative voltage and applies a larger electric field driving the FLC molecules towards the polarizer axis 512 in the dark state. For a substantially bright image, V_{WIN} may be decreased below ½(V_{PIXH}−V_{PIXL}) during an illumination period, which makes V_{PIXH} a more positive voltage and applies a larger electric field driving the FLC molecule to rotate away from polarizer axis 512 in the bright state. The common window electrode voltage V_{WIN} may be adjusted in the opposite direction during balance periods to the adjustment during the illumination periods. This adjustment maintains dc-compensation while providing the benefits of a dynamically rotated optic axis rotation range during illumination periods.

Where possible with the drive circuit technology and process, video data dependent adjustment of display drive may also be accomplished by changing V_{PIXH} and V_{PIXL}. For a substantially dark image, V_{PIXL}, may be reduced to create a more negative voltage across the FLC layer for substantially dark pixels. For a substantially bright image, V_{PIXH} may be increased to create a more positive voltage across the FLC layer for substantially bright pixels. Additionally, video data dependent adjustment of display drive may be accomplished with a combination of adjustments of V_{WIN}, V_{PIXH}, and V_{PIXL}. Again, the PWM waveforms of the pixels between voltages V_{PIXH} and V_{PIXL} that provide the grayscale of the pixel according to the pixel data values may remain unchanged in this embodiment.

Video data dependent adjustment of display drive may be accomplished by determining a characteristic related to the brightness of the input image. For example, the characteristic could be determined from the image data values of the input image. The characteristic may include, but is not limited to, parameters such as the average, the minimum, the maximum, the distribution, a histogram, or the standard deviation of the image data values of the input image. The characteristic could be calculated from all image data values of the input image or a subset of the image data values. The characteristic could weight parameters of all component colors equally or give more weight to one component color over others.

Standard video sources provide all component colors, for example red, green, and blue (RGB), for each pixel in an image in raster order. However, to display the image in field sequential color mode, the component colors of the input image are displayed one at a time. Therefore, a display using field sequential color typically must store an entire input image before displaying the image. Using the stored data, such a display may be able to determine the characteristic using more advanced processing of the input image data. For example, the characteristic could be determined from the average brightness of the darkest region of the input image larger than a given size. Other ways of determining the characteristic from the stored input image data that take into account the apparent brightness of the input image to a viewer are possible. For example, the characteristic could be determined from the number of image data values over a particular threshold or the average of the image data values in a region larger than ½, ¼ or ⅛ of the total image area.

A transfer function could be applied between the characteristic and an adjustment of the display drive field. For example, the transfer function could be applied between the characteristic and adjustments of the common window electrode V_{WIN} for an FLC cell. The transfer function could be a linear transfer function between the characteristic and the drive field adjustments. Alternately, the transfer function could compensate for the non-linear response of the optical states due to changes in drive field. For example, the response of the dark state optic axis and the bright state optic axis to changes in liquid crystal drive field may be non-linear. In addition, as illustrated by optical transmission curve 710 in FIG. 7, the optical response of a liquid crystal display with crossed polarizers varies according to a sin² x function of the optic axis. Therefore, the transfer function could compensate for both the non-linear response of the optic axis to the display drive field and the non-linear optical response of the liquid crystal display to optic axis position, providing a linear optical response based on the characteristic.

The transfer function could account for the perceptual response of the viewer to different brightness levels. For example, a perceptual response curve could be determined by experimentally measuring the ability of viewers to perceive changes in grayscale for images of varying average brightness. In an embodiment of the invention, the transfer function compensates for the non-linear nature of the optical response relative to drive field and adjusts the drive fields so that the optical response varies according to a perceptual response curve based on the characteristic. In this embodiment, the display drive fields are adjusted according to a perception-based model.

The transfer function could account for multiple characteristics of the input image to produce drive field adjustments. For example, the transfer function could accept the minimum, average, and maximum brightness of an input image to determine the drive field adjustments. The transfer function could apply equal weights to multiple characteristics of the input image or weight one characteristic more heavily than others in determining the drive field adjustments.

The transfer function could also adjust the optical states based on the characteristics of multiple input images. It may take several seconds for the viewer's eye to adjust from a substantially bright image to a substantially dark image. Therefore, the transfer function could apply a temporal filter to the characteristic from multiple images from a video source. The filter could have an impulse response that is related to the speed with which the viewer's eye adjusts to the relative brightness of the input images. The filter could have a different impulse response time for transitions from darker images to brighter images than the impulse response time for transitions from brighter images to darker images.

As described above, FLCs typically require a zero time-averaged DC field to prevent charge accumulation at the FLC-alignment layer interfaces that contributes to image sticking. With respect to charge accumulation that causes image sticking, the time-constant for charge to accumulate and decay may be in the range of minutes to hours. Using dc-compensated PWM waveforms prevents charge accumulation by ensuring that there is no net DC field across the FLC. However, dc-compensation drive waveforms typically require a balance period for each illuminated period during which the FLC is driven with a complementary waveform. Because the illumination source is turned off during the balance periods, the resulting duty cycle of the illumination source is approximately 50%. This low duty cycle reduces the overall brightness of the display.

Embodiments of the invention contemplate the use of a liquid crystal material, such as an FLC, that has been formed with a base FLC with ions added to dope the base FLC to adjust its conductivity (resistivity) as described in copending U.S. patent application Ser. Nos. 12/794,267 and 13/007,297, the entire contents of which are incorporated herein by reference. In those applications, an FLC cell is disclosed including an FLC layer and an alignment layer, where the alignment layer may act as an insulating layer. In addition, methods and compositions for adjusting the conductivity of the FLC are described including adding ionizable compounds to the base FLC or resistive elements to the FLC.

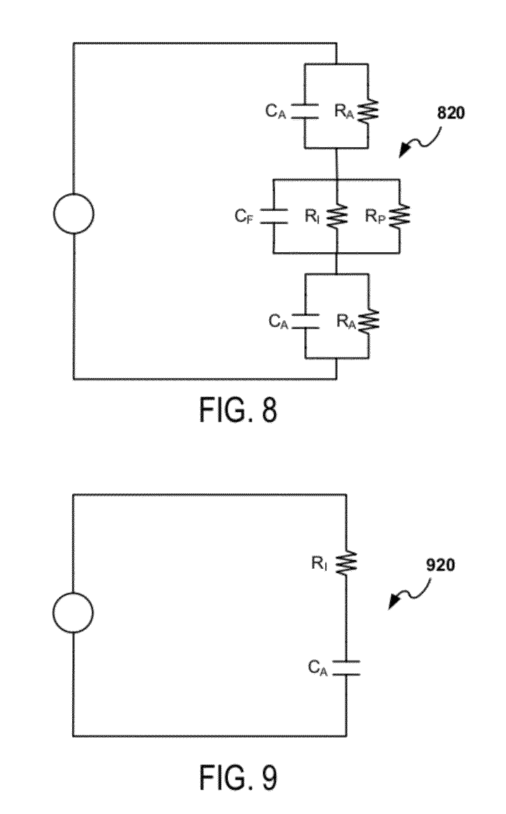

FIG. 8 shows a simplified equivalent circuit 820 of an FLC cell having an FLC layer between two alignment layers, such as the FLC cell 220 shown in FIG. 3. Each alignment layer 340-1, 340-2 is represented as a resistance R_{A} and capacitance C_{A} connected in parallel. Similarly, the FLC layer 330 can be represented as a capacitance C_{F} in parallel with a non-linear, history-dependent resistor. The dominant contributions to the FLC's conductivity are the motion of ionic charge carriers (represented by R_{I}) and the flow of the FLC's polarization charge (represented by R_{P}). The ionic charge flow contribution to the FLC's resistance is influenced by ionization and recombination rates in the bulk, by the dynamics of ionic adhesion/release by surfaces, and by time-dependent spatially varying ion/source densities within the thickness of the FLC layer. These mechanisms for ionic charge flow and their relative importance can vary strongly with temperature.

The material for the alignment layers and the material for the FLC can be selected such that the alignment layer resistance is much greater than that of the FLC. In such cases, the resistance R_{A} of the alignment layer can be set to R_{A}=∞ in equivalent circuit 820, which effectively provides that resistance R_{A} can be omitted from equivalent circuit 820. The alignment layer is generally thin compared to the FLC. For example, the thickness of an alignment layer may typically be 20 nm, while the thickness of the FLC may be 800 nm. Other thicknesses can be used. With such differences in thickness, the capacitance C_{A} of an alignment layer is approximately one to two orders of magnitude larger than capacitance C_{F} of the FLC. Further, after FLC switching events, where the polarization switching current is near zero, the FLC's conductivity is dominated by the motion of ionic charge carriers, which conductivity is represented by R_{I} in the equivalent circuit.

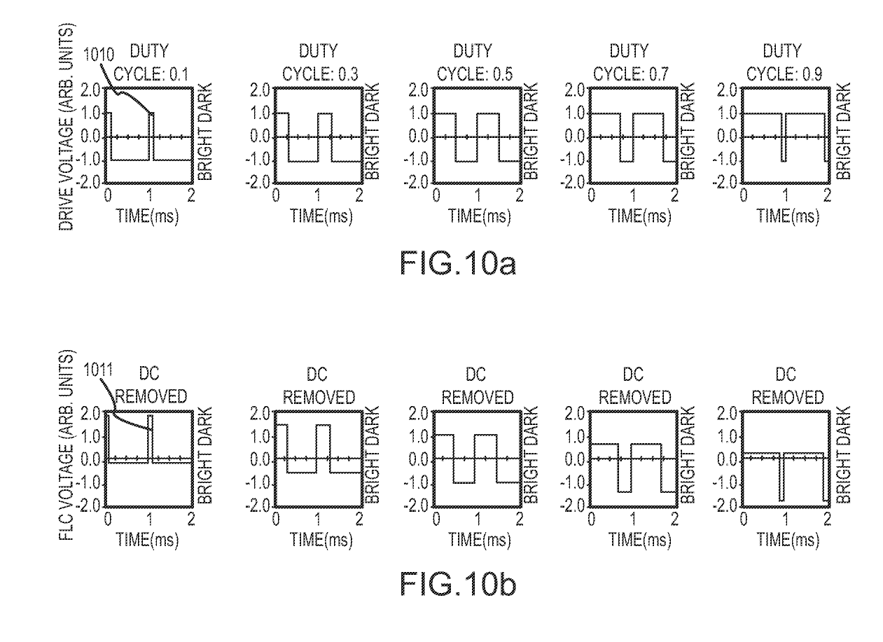

FIG. 9 shows a further simplified equivalent circuit 920 derived from equivalent circuit 820 of FIG. 8 based on selections of the materials used and the structural characteristics of the layers used for the FLC and alignment layers. As a consequence of C_{A}>>C_{F}, R_{A}≈∞, and R_{I}<<R_{P}, a first approximation to the electrical time constant of interest is ½R_{I}C_{A}. Alternatively, the two alignment layers may have different capacitances, where C_{IA} refers to the capacitance of one individual alignment layer, and C_{2A} refers to the capacitance of the other individual alignment layer. With these capacitances significantly greater than C_{F}, C_{A}, in the time constant ½R_{I}C_{A}, refers to C_{A}=2/(1/C_{1A}+1/C_{2A}). The time constant ½R_{I}C_{A} can be adjusted by selection of the materials of the FLC and alignment layers, selection of the structural characteristics such as thickness for these layers, or combinations of these selections. In an example embodiment, ½R_{I}C_{A} can be adjusted by adding ionizable compounds to a selected base FLC in order to lower R_{I} compared to that of an ionically clean version of the selected base FLC.

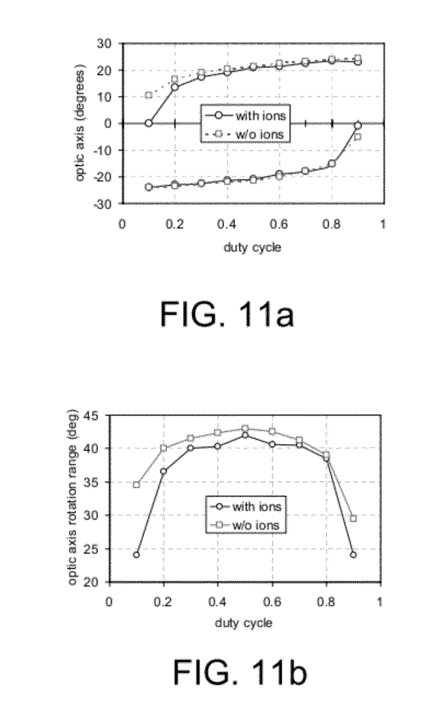

In an embodiment of the invention, an ionically doped FLC cell may be driven with a PWM waveform without dc-compensation. The alignment layers effectively act as an electrical high-pass filter, blocking the DC component to the waveform and passing the high frequency component of the drive waveform to the FLC. FIG. 10a illustrates PWM waveforms without dc-compensation that may be applied to the FLC cell between a pixel electrode and the common window electrode ranging from 10% to 90% duty cycle. For these PWM waveforms, the duty cycle corresponds to the desired grayscale brightness level of the pixel. FIG. 10b illustrates the PWM waveforms of FIG. 10a as applied to the FLC layer with the DC component removed by the alignment layers. If a pixel is switched between different grayscale brightness levels and the corresponding PWM waveform, the DC voltage across the FLC layer briefly becomes non-zero, but decays back to zero according to the time constant ½R_{I}C_{A}. This time constant may be adjusted by selecting R_{I} and C_{A} such that charge accumulated on the alignment layers, representing the “stuck” image, decays away faster than the time that image sticking may be apparent to the viewer. For example, ½R_{I}C_{A} could be set to less than 1/30^{th} of a second.

The decay time constant ½R_{I}C_{A} could be set by using a selected material of a selected thickness as an alignment layer. For example, a generic polyimide layer of a given thickness could be selected. The decay time constant could be set by manipulating the doping of the FLC to achieve the desired R_{I}. Alternately, for a given FLC having a given R_{I}, the decay time constant can be adjusted by selecting a value of C_{A} to produce the desired decay constant. For example, the desired value of C_{A} may be attained by selecting a particular material for the alignment layer or manipulating the structural characteristics such as alignment layer thickness to achieve a given C_{A} value.

Another consideration for selection of the characteristics of the FLC and alignment layers includes selecting the decay time constant, ½R_{I}C_{A}, such that it is substantially longer than the time, t_{SW}, to switch the liquid crystal between display states (e.g. bright to dark, comprising substantially contrasting optical states). Otherwise, the FLC may not switch fully and images may not be displayed. Combining these two factors for an appropriate decay time, the condition, t_{SW<}½R_{I}C_{A}<t_{VISION}, can be used to select materials and sizes for the FLC and alignment layers. The switching time of the FLC may be on the order of 50-1000 μs. Preferably, the switching time of the FLC is shorter than the field time. Therefore, the minimum time for the decay time constant ½R_{I}C_{A} could be set to be greater than a field time, for example, ⅓, ⅙, 1/9, or 1/12 of the frame time. Depending on the video source, which may have 24, 30, 50, or 60 frames per second, for example, the frame time may be between 1/24 of a second and 1/60 of a second. Therefore the field time may be on the order of 1/720 of a second to 1/72 of a second.

In an example embodiment, the decay time is desired to be in the range t_{SW}<½R_{I}C_{A}<t_{VISION}, where t_{VISION} is an acceptable decay time for image sticking. A generic polyimide alignment layer having a thickness of ˜20 nm and a dielectric constant of ˜4 may be used, with capacitance C_{A} of approximately 200 nF/cm². Using a minimum decay constant time greater than 1/720 s and t_{VISION}= 1/30 s, the value of R_{I} is set to the range 14 kΩ<R_{I}<0.3 MΩ for a cell area of 1 cm². For a typical FLC layer whose thickness is on the order of 1 μm, the electrical resistivity, ρ_{I}, for ionic charge carriers should correspondingly be in the range 140 MΩ·cm<ρ_{I}<3 GΩ·cm. In practice, the upper limit for t_{VISION} of 1/30^{th} s may be excessively stringent, i.e., it may be visually acceptable for image sticking to persist for a larger fraction of a second or multiple seconds so that higher electrical resistivities may be acceptable.

While the ionic doping of the FLC layer and use of alignment layers as insulating layers may reduce the persistence of image sticking in the FLC cell, it may have effects on the optic axis rotation range (Δ_{Θ}) of the FLC layer. As shown in FIG. 10b, as the extremes of duty cycle are approached (e.g., less than 10% or greater than 90%), the voltage across the FLC with dc-removed during a portion of the switching period approaches zero. For example, PWM waveform 1010 of FIG. 10a illustrates a 10% duty cycle PWM waveform applied to the FLC cell. As shown in the corresponding voltage across the FLC layer after decay time constant ½R_{I}C_{A}, shown by waveform 1011 of FIG. 10b, the voltage across the FLC layer when the pixel electrode is driven to the low state V_{PIXL} approaches zero. As the voltage across the FLC layer is reduced, the analog response of the FLC layer to voltage field will affect the optic axis position.

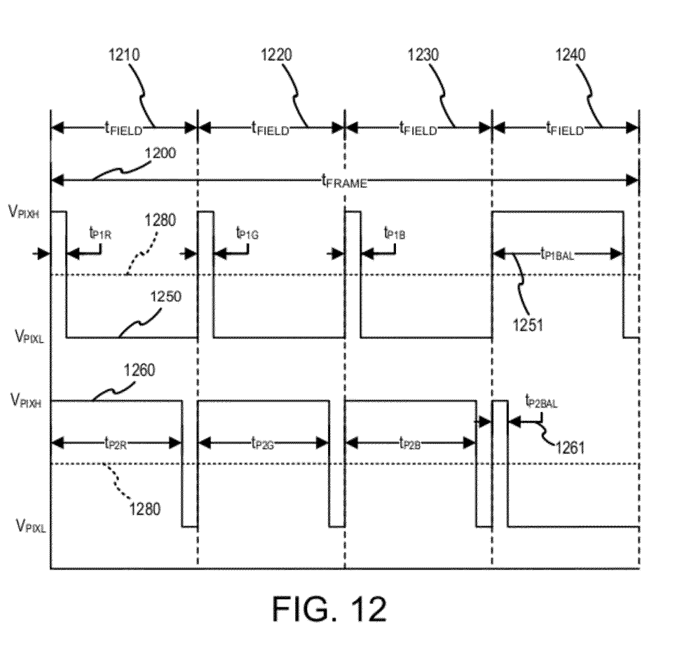

FIGS. 11a and 11b illustrate the effect on switching of the FLC optic axis for FLC cells with and without ions added. As shown in FIG. 11a, for extremes of duty cycle, the optic axis in an FLC cell with ions added may fail to effectively switch to the desired state. Therefore, while reducing the decay time constant of the FLC cell may reduce the perceptibility of image sticking, the FLCs with ions added have a reduced optic axis rotation range (Δ_{Θ}) at extremes of duty cycle. While the largest effect on optic axis rotation range (Δ_{Θ}) is at the extremes of duty cycle, FIG. 11b shows that even for duty cycles of 0.2 or 0.8, the optic axis rotation range (Δ_{Θ}) of FLCs, including those with ions added to reduce the perceptibility of image sticking, may be greatly reduced. For example, FIG. 11b shows that the optic axis rotation range (Δ_{Θ}) may be approximately 42 degrees for the FLC with ions added when the duty cycle of the PWM drive waveform across the FLC cell is 0.5. With a duty cycle of 0.2, the optic axis rotation range (Δ_{Θ}) for the FLC may be reduced to approximately 37 degrees.

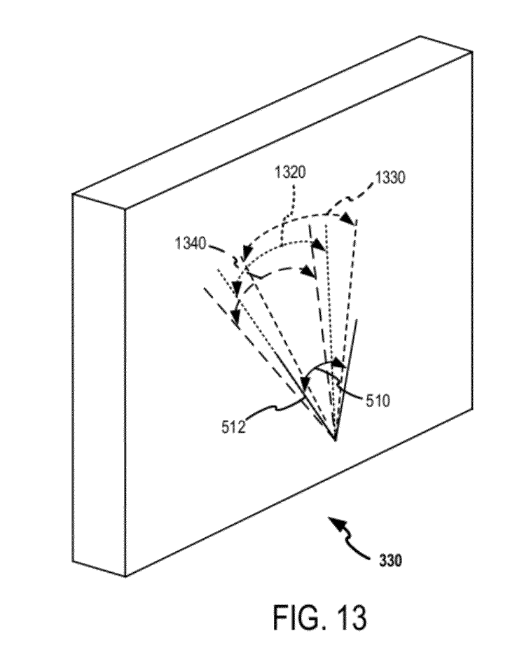

In various embodiments, an FLC cell with ions added such that the decay time is t_{SW}<½R_{I}C_{A}<t_{VISION} may be driven with a field sequential color, PWM grayscale waveform that is not fully dc-compensated. For example, FIG. 12 illustrates a frame period 1200 that is split into four equal field periods, 1210, 1220, 1230 and 1240. For this example, field periods 1210, 1220 and 1230 are illumination periods where the panel is illuminated by an illumination source with component colors red, green, and blue, respectively. Field period 1240 is a balance period that is not illuminated. Pixel 1 drive waveform 1250 shows the PWM waveform between a high pixel voltage V_{PIXH} and a low pixel voltage V_{PIXL}, for a pixel with 10% grayscale brightness. Pixel 1 is driven to V_{PIXH} during balance period 1240 for a time 1251 that is inversely proportional to the aggregate time that the pixel is driven to V_{PIXH} during field periods 1210, 1220, and 1230. Pixel 2 drive waveform 1260 shows the PWM waveform for a pixel with 90% grayscale brightness. Pixel 2 is driven to V_{PIXH} during balance period 1240 for a time 1261 that is inversely proportional to the aggregate time that the pixel is driven to V_{PIXH} during field periods 1210, 1220, and 1230. Waveform 1280 shows that the common window electrode voltage V_{WIN} is driven to an intermediate voltage of ½(V_{PIXH}−V_{PIXL}) throughout the frame period 1200. However, in this example, time period 1251 during which pixel 1 is driven to V_{PIXH} does not completely balance the total time that pixel 1 was driven to V_{PIXL} during field periods 1210, 1220, and 1230. Similarly, time period 1261 during which pixel 2 is driven to V_{PIXH} does not completely balance the total time that pixel 2 was driven to V_{PIXL} during time periods 1210, 1220, and 1230.

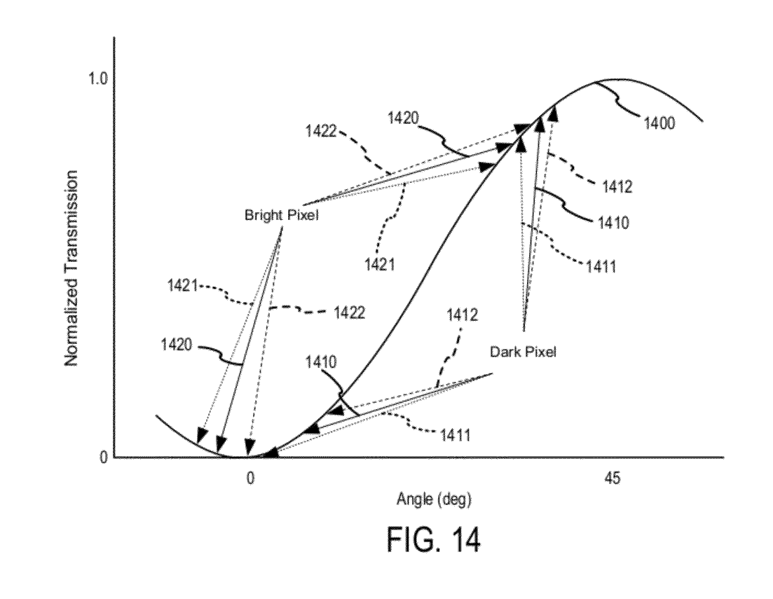

FIG. 13 illustrates the effect on the optical states of an FLC layer driven with the waveforms of FIG. 12. Optic axis rotation range 510 shows the ideal 45 degree optic axis rotation range to produce a fully extinguishing dark state and a fully transmissive bright state with a polarizer aligned with axis 512. Optic axis rotation range 1320 shows the range of optical states for an ion doped FLC cell, rotated for best extinction with a 50% duty cycle PWM waveform. Optic axis rotation range 1330 shows the equilibrium optical states for pixel 1, driven according to waveform 1250 in FIG. 12. The equilibrium dark state optic axis for pixel 1 has drifted towards the bright state due to charge accumulation in the alignment layers. In addition, the equilibrium bright state optic axis for pixel 1 has also drifted towards the fully transmissive optic axis state. Optic axis range 1340 shows the equilibrium optic axis rotation range for pixel 2, driven according to waveform 1260 in FIG. 12. The equilibrium dark state optic axis for pixel 2 has drifted off the axis 512 of best extinction, and the equilibrium bright state optic axis for pixel 2 has drifted towards the dark state. Accordingly, while doping FLCs with ions to reduce the decay time constant ½R_{I}C_{A} reduces the perceptibility of image sticking caused by ion migration through the cell, using an unbalanced drive waveform with doped FLCs causes undesirable effects on the optic axis rotation range of the FLC at the extremes of PWM duty cycle.

According to embodiments of the invention, video data dependent adjustment of display drive may be used to improve the image quality of FLC displays using doped FLCs driven with PWM waveforms that are not fully dc-compensated. Specifically, the optical states of the FLC may be adjusted depending on the pixel data values in the input image data. If the input image data is substantially dark, the display drive is modified such that the optic axis rotation range (Δ_{Θ}) will rotate to an equilibrium optic axis rotation range (Δ_{ΘD}) for dark pixels such that the equilibrium dark state for dark pixels is rotated for improved extinction. If the input image data is substantially bright, the display drive is modified such that the optic axis rotation range (Δ_{Θ}) will rotate to an equilibrium optic axis rotation range (Δ_{ΘB}) for bright pixels such that the equilibrium bright state for bright pixels is rotated for improved transmission.

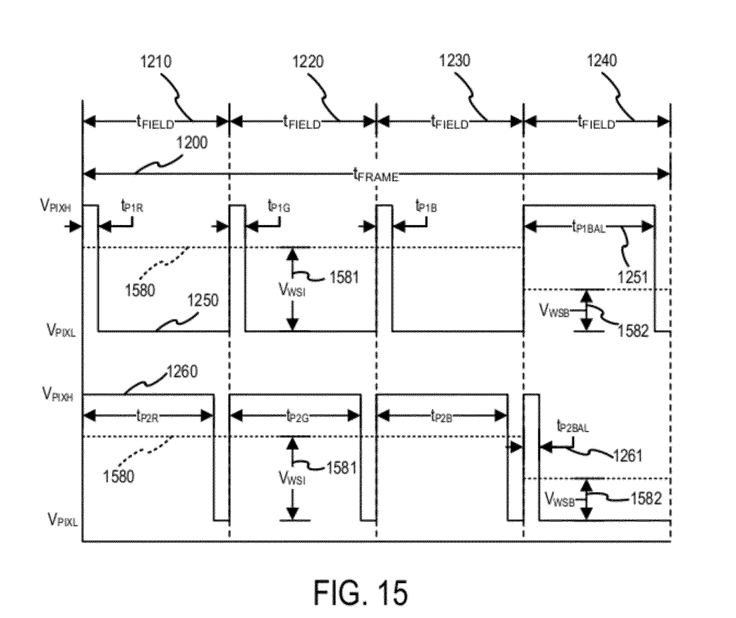

FIG. 14 illustrates the advantages of video data dependent adjustment of display drive with regard to optical throughput of the display panel according to various embodiments. Normalized optical transmission curve 1400 depicts the relationship between optical throughput and optic axis angle (Θ) relative to the polarizer orientation. Without data dependent adjustment of display drive, optic axis rotation range 1410 shows the optical states for dark pixels driven according to drive waveform 1250 in FIG. 12. Optic axis rotation range 1420 shows the optical states for bright pixels driven according to drive waveform 1260 in FIG. 12. If the input image is substantially dark, the optical states may be adjusted by rotating the optic axis rotation range for dark pixels to dynamically adjusted optic axis rotation range 1411. Correspondingly, the optical states for bright pixels are rotated to dynamically adjusted optic axis rotation range 1421. This produces dynamically improved extinction for dark pixels at the expense of loss in brightness for bright pixels. If the input is substantially bright, the optical states may be adjusted by rotating the optical states for bright pixels to dynamically adjusted optic axis rotation range 1422. Correspondingly, the optical states for dark pixels are rotated to dynamically adjusted optic axis rotation range 1412. This produces dynamically higher brightness for bright pixels at the expense of more light throughput for dark pixels.

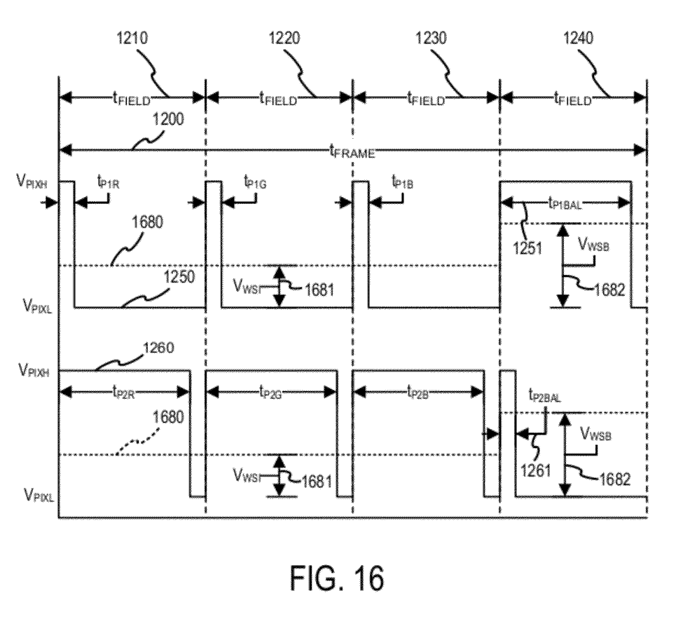

The video data dependent adjustment of display drive for a doped FLC may be accomplished by changing the voltage of the common window electrode V_{WIN}. In this embodiment, adjusting the common window voltage V_{WIN} to adjust the optic axis rotation range may be independent of the pixel drive waveforms. FIG. 15 shows video data dependent adjustment of display drive using common window electrode voltage V_{WIN} for a substantially dark image. As in FIG. 12, drive waveforms 1250 and 1260 for pixel 1 (substantially dark) and pixel 2 (substantially bright) are not fully dc-compensated. V_{WIN} drive waveform 1580 is adjusted during illuminated field periods 1210, 1220 and 1230 to window illumination step voltage V_{WSI} (1581) such that V_{WIN} is greater than ½(V_{PIXH}−V_{PIXL}). During balance period 1240, V_{WIN} drive waveform 1580 is adjusted to window balance step voltage V_{WSB} (1582) by an adjustment that is opposite of the adjustment during the illuminated field periods. The video data dependent adjustment of display drive shown by window step voltages V_{WSI} and V_{WSB} dynamically adjusts the optic axis rotation ranges such that the dark state optic axis for dark pixels has improved extinction.

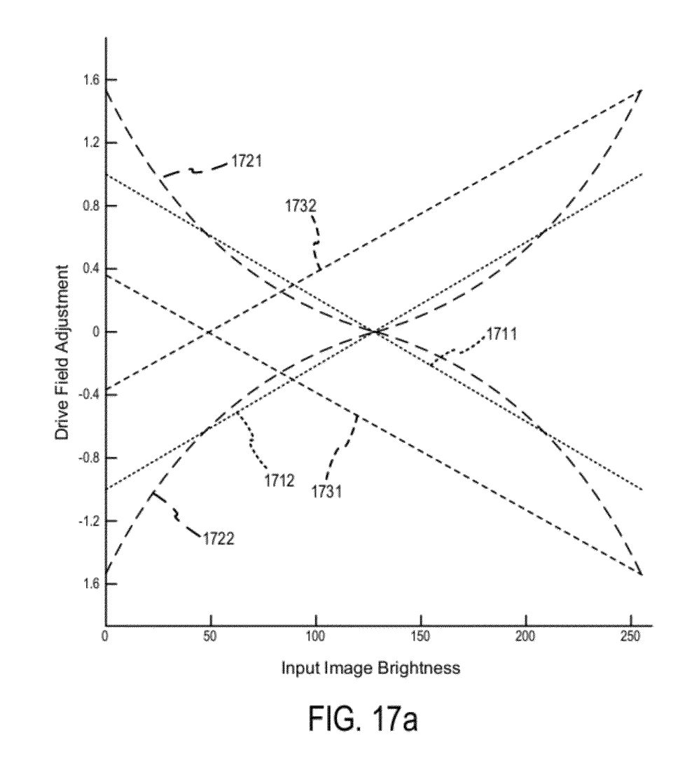

FIG. 16 shows video data dependent adjustment of display drive using common window electrode voltage V_{WIN} for a substantially bright image. V_{WIN} drive waveform 1680 is adjusted during illuminated field periods 1210, 1220 and 1230 to window step voltage V_{WSI} (1681) such that V_{WIN} is less than ½(V_{PIXH}−V_{PIXL}). During balance period 1240, V_{WIN} drive waveform 1680 is adjusted to window step voltage V_{WSB} (1682) by an adjustment that is opposite of the adjustment during the illuminated periods. The video data dependent adjustment of display drive shown by window step voltages V_{WSI} and V_{WSB} dynamically adjusts the optic axis rotation ranges such that the bright state optic axis for bright pixels has improved transmission.

Other adjustments of common window electrode voltage V_{WIN} using video data dependent adjustment of display drive may also provide advantages. For example, common electrode voltage V_{WIN} may be adjusted only during one or more of the illumination periods 1210, 1220, and 1230 to window illumination step voltage V_{WSI} shown by step voltage 1581 or 1681. Conversely, common electrode voltage V_{WIN} may be adjusted only during one or more balance periods 1240 to window balance step voltage V_{WSB} shown by step voltage 1582 or 1682. Additionally, the adjustment of window step voltages V_{WSI} and V_{WSB} does not need to be equal. For example, the adjustment to V_{WSB} could be greater than the adjustment to V_{WSI}.

Where possible with the drive circuit technology and process, video data dependent adjustment of display drive may also be accomplished by changing V_{PIXH} and V_{PIXL}. For a substantially dark image, V_{PIXL} may be reduced to create a more negative voltage across the FLC layer for substantially dark pixels. For a substantially bright image, V_{PIXH} may be increased to create a more positive voltage across the FLC layer for substantially bright pixels. Additionally, video data dependent adjustment of display drive may be accomplished with a combination of adjustments of V_{WIN}, V_{PIXH}, and V_{PIXL}.

In other embodiments, video data dependent adjustment of display drive contemplates changing the drive field on a pixel-by-pixel basis, independently of other pixels. A pixel adjustment value, either determined by a circuit local to the pixel, or determined by a circuit outside the pixel array and communicated to the pixel, is used to modify the optical states of the pixel based on the effect of the pixel states on the optic axis rotation range of the pixel. For example, a particular pixel could select a high drive voltage V_{SELPIXH} and a low drive voltage V_{SELPIXL} from a range of pixel voltages based on the pixel adjustment value. In this way, as the pixel drive waveform approaches the extremes of duty cycle, the pixel adjustment value compensates for the change in optical states of the FLC for the particular pixel by adjusting the drive field of the pixel.

Video data dependent adjustment of display drive may be accomplished by determining a characteristic related to the brightness of the input image. For example, the characteristic could be determined from the pixel data values of the input image. The characteristic may include, but is not limited to, parameters such as the average, the minimum, the maximum, the distribution, a histogram, or the standard deviation of the pixel data values of the input image. The characteristic could be based on parameters of all pixel data values of the input image or a subset of the pixel data values. The characteristic could weight parameters of all component colors equally or give more weight to one component color over others.

Standard video sources provide all component colors, for example red, green, and blue (RGB), for each pixel in an image in raster order. However, to display the image in field sequential color mode, the component colors of the input image are displayed one at a time. Therefore, a display using field sequential color typically must store an entire input image before displaying the image. Using the stored data, such a display may be able to determine the characteristic using more advanced processing of the input image data. For example, the characteristic could be determined from the average brightness of the darkest region of the input image larger than a given size. Other ways of determining the characteristic from the stored input image data are possible that take into account the apparent brightness of the input image to a viewer.

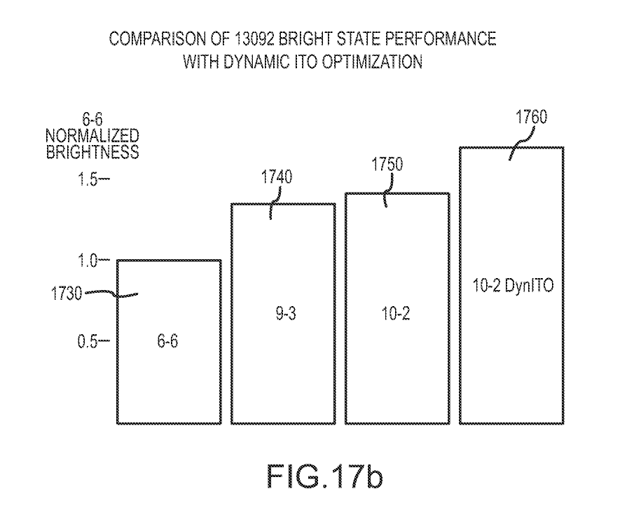

A transfer function could be applied between the characteristic and adjustment of the pixel drive fields of the display. For example, the transfer function could be applied between the characteristic and adjustments of the common window electrode V_{WIN} for an FLC cell. FIG. 17a shows examples of a transfer function between a characteristic indicating input image brightness and adjustments of pixel drive fields. The transfer function may produce an adjustment for illuminated periods and an adjustment for balance periods. For example, a transfer function may include an illumination window step function 1711 between input image brightness and adjustment of V_{WIN} during illumination periods and a balance window step function 1712 between input image brightness and adjustment of V_{WIN} during balance periods.

The transfer function could be a linear transfer function between the characteristic and the drive field adjustments as shown by illumination window step function 1711 and balance window step function 1712. Alternately, the transfer function could compensate for the non-linear response of the optical states due to change in drive field. For example, the response of the dark state optic axis and the bright state optic axis to changes in liquid crystal drive field may be non-linear. In addition, as illustrated by optical transmission curve 710 in FIG. 7, the optical response of a liquid crystal display with crossed polarizers varies according to a sin² x function of the optic axis. Therefore, the transfer function could compensate for both the non-linear response of the optic axis to the display drive field and the non-linear optical response of the liquid crystal display to optic axis position, providing a linear optical response based on the characteristic.

The transfer function could account for the perceptual response of the viewer to different brightness levels. For example, a perceptual response curve could be determined by experimentally measuring the ability of viewers to perceive changes in grayscale for images of varying average brightness. In an embodiment of the invention, the transfer function compensates for the non-linear response of the optical states to display drive field and adjusts the drive field so that the optical states vary based on the characteristic according to the perceptual response curve. Example non-linear illumination window step function 1721 and balance window step function 1722 may compensate for the non-linear response of optical states due to change in drive field and the non-linear perceptual response of viewers. It will be appreciated that once the perceptual response curve and the non-linear optical response with respect to drive field are determined, the transfer function may be calculated to provide the desired perceptual response curve. In this embodiment, the display drive fields are adjusted according to a perception-based model.

Operation of video data dependent adjustment of display drive using window voltage V_{WIN} with a doped FLC according to an embodiment of the invention is illustrated by considering illumination window step function 1711 and balance window step function 1712 of FIG. 17a in conjunction with FIGS. 12, 15 and 16. For this example, V_{PIXH}=5V, V_{PIXL}=0V, and the nominal V_{WIN} voltage 1280 without video data dependent adjustment of display drive is 2.5V. Also for this example, balance time period 1240 is equal in time to each of illumination periods 1210, 1220, and 1230. The FLC layer of a 10% brightness pixel, shown in waveform 1250 of FIG. 12, will have a DC offset of −1V. Therefore, the field across the FLC layer when the pixel is driven low for these conditions will be reduced to −1.5V. For an input image with a characteristic that indicates a substantially dark image, such as an image with an average brightness less than 128 for an eight bit image (per color), the drive field is adjusted to improve extinction. For example, for a fully dark image having an average brightness of zero, illumination window step function 1711 adjusts window step voltage V_{WSI} by +1V for illumination periods. The balance window step function 1712 adjusts window step voltage V_{WSB} by −1V for balance periods. The 10% brightness pixel 1250 now has a slightly more negative DC offset, determined by the average DC offset between pixel drive waveform 1250 and V_{WIN} drive waveform 1280, equal to −1.325 V. However, when pixel waveform 1250 is low the drive field is 3.5 V and the corresponding field across the FLC layer will be −2.175 V. The more negative drive field using video data dependent adjustment of display drive will rotate the optic axis rotation range for better extinction for the 10% pixel (and other substantially dark pixels). Correspondingly, video data dependent adjustment of display drive can be used to rotate the optic axis rotation range for better transmission when the input image is substantially bright, for example, when the average input image brightness is greater than 128 for an eight-bit image (per color). For input images having brightness characteristics between a fully dark characteristic such as an average brightness of zero and a fully bright characteristic such as an average brightness of 255 for an eight-bit image (per color), the adjustment of window voltage V_{WIN} may be intermediate values according to illumination window step function 1711 and balance window step function 1712. For an image with a characteristic of 50% brightness, no adjustment of window step voltages V_{WSI} and V_{WSB} is made according to functions 1711 and 1712. Thus, for an input image with a 50% brightness characteristic, window voltage V_{WIN} will have a waveform corresponding to waveform 1280 of FIG. 12.

It will be appreciated that the zero crossing point for the transfer function may depend on the rotation of the FLC cell relative to the polarizers. For example, FIG. 5 illustrates optic axis rotation range 520 that is centered within a 45 degree angle from polarizer axis 512. For a variety of reasons, it may be advantageous to center the optic axis rotation range such that the dark state optic axis is substantially aligned with polarizer axis 512. For this configuration, the zero crossing point for the transfer function may be different than a 50% brightness characteristic. For example, illumination window step function 1731 and balance window step function 1732 may illustrate a transfer function for an FLC cell aligned such that the dark state optic axis for a 50% brightness pixel is substantially aligned with polarizer axis 512.

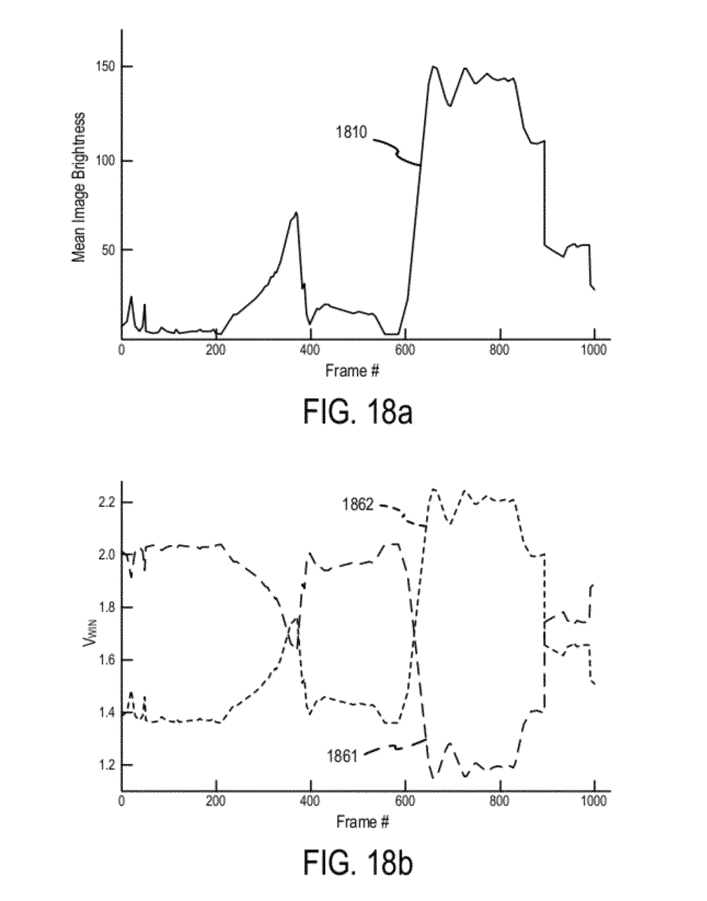

FIGS. 18a and 18b illustrate in more detail how the transfer function modifies the window step voltages V_{WSI} and V_{WSB} shown in FIGS. 15 and 16 over time. An example FLC cell is constructed according to various embodiments with the dark state optic axis for a dc-balanced pixel substantially aligned with polarizer axis 512. The FLC cell may be driven with pixel voltages of V_{PIXH}=3.4V and V_{PIXL}=0V. The FLC cell may be driven with an un-balanced drive waveform according to FIGS. 15 and 16, with various ratios of aggregate illuminated period time to aggregate balance period time including ratios of 6-6, 9-3, 10-2, or other un-balanced drive ratios. The window step voltages V_{WSI} and V_{WSB} are adjusted according to a transfer function illustrated by window illumination step function 1731 and window balance step function 1732 in FIG. 17a, respectively. FIG. 18a illustrates the average brightness waveform 1810 of a sample sequence of 1000 frames of an input video stream. FIG. 18b shows plots of V_{WSI} (1861) and V_{WSB} (1862) for the FLC cell according to this configuration for the frame sequence of FIG. 18a.

The transfer function for a display may be programmable. For example, the transfer function may be stored as a look-up-table (LUT) in non-volatile memory of the display system. The transfer function may be interpolated between the set-points of the LUT. The transfer function may be linearly interpolated between the set-points of the LUT. Alternately, the transfer function may be stored in the display system as a polynomial function or other type of function. The display may calculate the drive field adjustment according to the function and the characteristic of the input image.

The transfer function could account for multiple characteristics of the input image to produce an optical state adjustment. For example, the transfer function could accept the minimum, average, and maximum brightness of an input image to determine the drive field adjustment. The transfer function could apply equal weights to multiple characteristics of the input image or weight one characteristic more heavily than others in determining the drive field adjustment.

The transfer function could also adjust the optical states based on the characteristics of multiple input images. For example, the transfer function could apply a temporal filter to the characteristic from multiple images from a video source. It may take several seconds for the viewer's eye to adjust from a substantially bright image to a substantially dark image. Therefore, the filter could have an impulse response that is related to the speed with which the viewer's eye adjusts to the relative brightness of the input images. The filter could have a different impulse response time for transitions from darker images to brighter images than the impulse response time for transitions from brighter images to darker images.

The filter could have an impulse response that is related to the decay time constant of the FLC. For example, the transfer function could apply a filter which has an impulse response equal to the decay time constant of the FLC. In this example, if the decay time constant of the FLC is set to equal t_{VISION}, where t_{VISION}= 1/30^{th} s, and the video frame rate is 60 frames per second, the transfer function would be set to have an impulse response equal to two frames. This could be implemented with a simple second order finite impulse response filter. The transfer function could account for multiple characteristics from multiple images according to various embodiments.

It will be appreciated that a frame period may be divided into many combinations of illumination periods and balance periods. For a variety of reasons, it may be advantageous to have a color field rate greater than 3× the frame rate. It will also be appreciated that the illumination periods do not have to be equivalent time periods to the balance periods. By way of example, the frame period could be broken up into combinations of illumination periods and balance periods that result in ratios of aggregate illuminated time to aggregate balance time of 6-6, 9-3, or 10-2, respectively. Additionally, the balance periods could be positioned anywhere within the frame period, for example, the balance periods could come before the illumination periods, between the illumination periods, or after the illumination periods.

FIG. 17b shows the improvements in brightness for a doped FLC cell according to various embodiments of the invention. Brightness level bar 1730 shows the brightness for a fully dc-compensated PWM pixel drive waveform with a ratio of aggregate illumination time to aggregate balance time of 6-6 for a particular doped FLC mixture. Bar 1740 shows the normalized brightness of a PWM pixel drive waveform with a ratio of aggregate illumination time to aggregate balance time of 9-3. Bar 1750 shows the normalized brightness of a PWM pixel drive waveform with a ratio of aggregate illumination time to aggregate balance time of 10-2. Bar 1760 shows the normalized brightness of a PWM pixel drive waveform with a ratio of aggregate illumination time to aggregate balance time of 10-2 using video data dependent adjustment of display drive according to embodiments of the invention.

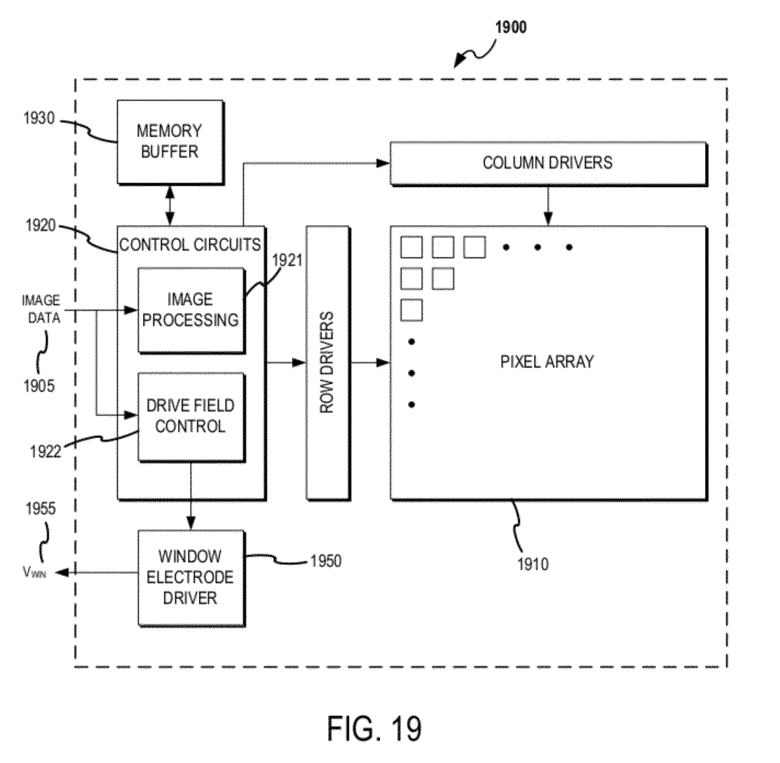

FIG. 19 illustrates a display panel according to various embodiments of the invention. Display panel backplane 1900 includes an array of pixels 1910, control circuit block 1920, memory buffer(s) 1930, and window electrode driver 1950. Image data 1905 includes image data values for an input image or series of input images in a video data stream. Control circuit block 1920 contains logic and memory circuits to control the operation of the several blocks in the display panel backplane 1900. Control circuit block 1920 may process image data values in image data 1905 to generate pixel drive states for the array of pixels based on the image data values. Control circuit block 1920 may store image data temporarily in memory buffer(s) 1930 before generating pixel drive states for the array of pixels. The pixel drive states may be based on one or more of the image data values. The pixel drive states may include grayscale values. The pixel drive states may include grayscale values for each component color including a red grayscale component, a green grayscale component, and a blue grayscale component. The pixels may switch between a low pixel level and a high pixel level according to a PWM waveform determined by the pixel drive states.

Control circuit block 1920 may include image processing block 1921 and drive field control block 1922. Drive field control block 1922 processes image data to determine a characteristic related to the brightness of the image data values. Drive field control block 1922 may also include a transfer function that adjusts the window electrode voltage 1955 using window electrode driver 1950, which may be a digital to analog converter (DAC) to convert a digital output of drive field control block 1922 to window electrode voltage 1955. The window electrode voltage 1955 is coupled to the common window electrode of the FLC cell by way of a direct connection from the display panel or a connection through a printed circuit board or other package for the display panel.

Display panel backplane 1900 may be designed in accordance with microdisplay architectures described in U.S. patent application Ser. No. 11/969,734, entitled DIGITAL DISPLAY and/or U.S. Pat. No. 7,283,105, entitled MICRODISPLAY AND INTERFACE ON SINGLE CHIP, which describe microdisplay backplanes with integrated frame buffers capable of accepting standard raster-order video signals and displaying in color sequential mode. Alternately display panel backplane 1900 may be designed with a different architecture that accepts input image data and applies a drive field using pixel electrodes. A display system according to an embodiment of the invention could have an external display controller chip that includes portions of the various circuit blocks of display panel backplane 1900.

Another embodiment of the present invention sets the adjustment parameters of video data dependent adjustment of display drive on a device-by-device basis. For example, a reflective microdisplay device with a doped FLC layer may be manufactured according to embodiments of the invention. The FLC may be driven with an unbalanced PWM waveform like those described previously with regard to FIG. 12. The optical throughput or equilibrium optic axis of the FLC could then be measured using a measurement apparatus for measuring light intensity or polarization. The optical state offset required to achieve a desired optical state could then be recorded. A display drive offset could be determined from the optical state offset and the display drive offset could be programmed in non-volatile memory local to the display. The display drive offset could be used to set the maximum and minimum drive field adjustments of transfer functions according to FIG. 17. The non-volatile memory could be an E²PROM memory. The non-volatile memory could be on a separate component of the display device that is coupled to the display substrate, or in other embodiments, the non-volatile memory could be on the display substrate itself. Alternately, the optical state offset could be determined by repeatedly setting the adjustment of display drive and measuring the result. When the desired adjusted equilibrium optical state is achieved, the amount of display drive correction is programmed into the non-volatile memory for the particular display device. The optical state offset could be measured for a variety of different PWM waveforms. In this way, the transfer function could be programmed using a look-up-table of input image brightness characteristic versus display drive adjustment. The transfer function could be interpolated between the set-points of the look-up-table. The transfer function could be linearly interpolated between the set-points of the look-up-table.

It will be appreciated that video data dependent adjustment of display drive may provide advantages in image quality including increased brightness and/or contrast ratio for other liquid crystal display technologies. For example, video data dependent adjustment of display drive may be used with any liquid crystal display technology where the polarization rotation of light passing through the liquid crystal layer is less than fully extinguished in a dark state and/or less than fully transmissive in a bright state. Additionally, video data dependent adjustment of display drive may be applied to applications where liquid crystals materials have optical states that are affected by a time-dependent component of a display drive waveform. In particular, video data dependent adjustment of display drive may be used with other liquid crystals that are doped with ionic compounds to reduce the decay time constant of image sticking.

Additionally, it will be appreciated that video data dependent adjustment of display drive may be applied to other display technologies. For example, video data dependent adjustment of display drive may be applied to any display technology where the optical state switching is constrained by manufacturing or process parameters such that either the dark state is not fully dark or the bright state is not optimally bright under standard driving conditions.

The foregoing description has been presented for purposes of illustration and description. Furthermore, the description is not intended to limit embodiments of the invention to the form disclosed herein. While a number of exemplary aspects and embodiments have been discussed above, those of skill in the art will recognize certain variations, modifications, permutations, additions, and sub-combinations thereof.

What is claimed is:

1. A method of operating a display device to display an input image, the input image including image data values, wherein the display device includes an array of pixels, each pixel of the array of pixels operable to switch between a plurality of pixel drive fields according to one or more of the image data values, the plurality of pixel drive fields corresponding to a plurality of optical states, the plurality of optical states including a high intensity optical state and a low intensity optical state, the method comprising:
determining a characteristic from a plurality of the image data values of the input image, wherein the characteristic is related to brightness of the input image; and
adjusting at least one of the plurality of pixel drive fields based on the characteristic.

2. The method of claim 1, wherein if the characteristic is indicative of a substantially dark image, the plurality of pixel drive fields are adjusted such that the low intensity optical state is darker.

3. The method of claim 1, wherein if the characteristic is indicative of a substantially bright image, the plurality of pixel drive fields are adjusted such that the high intensity optical state is brighter.

4. The method of claim 1, wherein the plurality of pixel drive fields are linearly adjusted based on the characteristic.

5. The method of claim 1, wherein the characteristic is determined from at least one of an average brightness, a brightness histogram, a maximum brightness, or a minimum brightness of the pixel data values.

6. The method of claim 1, wherein the plurality of pixel drive fields are adjusted according to a perception-based model.

7. The method of claim 1, wherein the display device is a liquid crystal display.

8. The method of claim 1, wherein each pixel of the array of pixels includes a pixel electrode, the array of pixels driving the pixel electrodes to a plurality of pixel voltages, and wherein adjusting the plurality of pixel drive fields is independent of the plurality of pixel voltages.

9. The method of claim 8, wherein each of the array of pixels includes a pixel electrode and the plurality of pixel drive fields are determined by the electric field potential between the pixel electrodes of the array of pixels and a common potential, and wherein adjusting the plurality of pixel drive fields includes adjusting the common potential.

10. The method of claim 1, wherein the display device is a liquid crystal display and the plurality of optical states are determined by an optic axis rotation range of a liquid crystal material of the liquid crystal display, the optic axis rotation range being less than 40 degrees.

11. A method of operating a display device to display an input image, the input image including image data values, wherein the display device includes an array of pixels, each pixel of the array of pixels operable to switch between a plurality of pixel drive fields according to one or more of the image data values, the plurality of pixel drive fields corresponding to a plurality of optical states, the method comprising:
determining an effect on the plurality of optical states for one or more of the array of pixels due to temporal DC offsets of pixel drive fields of the one or more of the array of pixels;
determining a characteristic from a plurality of the image data values of the input image; and
adjusting the plurality of pixel drive fields based on the characteristic.

12. The method of claim 11, wherein the display device is a liquid crystal display, the pixel drive fields are applied to a liquid crystal layer of the liquid crystal display, and wherein the plurality of optical states are determined by an optic axis of the liquid crystal layer, and the temporal DC offsets shift the optic axis of the liquid crystal layer.

13. The method of claim 12, wherein adjusting the pixel drive fields comprises adjusting a common voltage applied to a common electrode of the array of pixels.

14. The method of claim 11, further comprising determining the characteristic from a plurality of input images to be displayed sequentially.

15. A liquid crystal display device for displaying an input image, the input image including image data values, comprising:
an array of pixel electrodes, the array of pixel electrodes switchable between a plurality of voltage states;
a common electrode driven by a common voltage; and
a layer of liquid crystal material between the array of pixel electrodes and the common electrode, the layer of liquid crystal material having an optic axis, the optic axis determined by a voltage field between the array of pixel electrodes and the common electrode,
wherein the display device is configured to determine a characteristic relating to the brightness of the input image from a plurality of the image data values and adjust the common voltage based on the characteristic.

16. A liquid crystal display device for displaying an input image, the input image including image data values, the display device comprising:
a first substrate including an array of pixels, each pixel of the array of pixels including a pixel electrode, the array of pixels operable to drive the pixel electrodes to a plurality of pixel voltages including a high pixel voltage and a low pixel voltage;
a second substrate parallel to the first substrate comprising a common electrode driven to a common voltage; and
a layer of liquid crystal material between the first substrate and the second substrate, an optic axis of the liquid crystal material for a pixel of the array of pixels determined by a pixel voltage field between the pixel electrode and the common electrode and an offset voltage field due to a temporal DC offset of the pixel voltage field,
wherein the display device is configured to adjust the common voltage based on a characteristic determined from a plurality of the image data values to compensate for the effect of the temporal DC offset of the pixel voltage field on the optic axis.

17. The liquid crystal display device of claim 16, wherein the display device is further configured to adjust the plurality of pixel voltages based on the characteristic.

18. The liquid crystal display device of claim 16, further comprising an illumination source to illuminate the display device with component colors sequentially, wherein the display device is configured to display the input image during a frame period, the frame period further divided into a plurality of illumination periods and balance periods that are displayed sequentially, and wherein during an illumination period corresponding to a component color of the input image and illuminated by the illumination source with the component color the pixels select one of the high pixel voltage or the low pixel voltage for first time periods proportional to the image data values of the component color of the input image and during a balance period the pixels select one of the high pixel voltage or the low pixel voltage for second time periods inversely proportional to the image data values for one or more of the component colors of the input image, and further wherein the common voltage is adjusted inversely during the balance period to an adjustment during the illumination period.

19. The method of claim 18, wherein the number of illumination periods is greater than the number of balance periods.

20. The method of claim 18, wherein the total time period of the illumination periods during a frame period is greater than the total time period of the balance periods during the frame period.

21. The liquid crystal display device of claim 16, wherein the liquid crystal material is a ferroelectric liquid crystal.

22. The liquid crystal display device of claim 16, wherein the liquid crystal material is doped with ions.

23. The liquid crystal display device of claim 22, further comprising an insulating material at a surface of the liquid crystal, the offset voltage field being across the insulating material, wherein the offset voltage field has a decay time constant dependent on the resistance of the liquid crystal material doped with ions and the capacitance of the insulating material, the decay time constant less than or equal to a maximum time for image sticking to be visually acceptable.

24. The liquid crystal display device of claim 23, wherein the liquid crystal is doped with ions such that the decay time constant is less than 100 milliseconds.

25. A method of operating a display device to display an input image, the input image including image data values, wherein the display device includes an array of pixels, the array of pixels operable to switch between a plurality of optical states by driving the array of pixels to a corresponding plurality of pixel drive fields, the method comprising:
determining an effect on the plurality of optical states for one or more of the array of pixels due to temporal DC offsets in the pixel drive fields; and
adjusting at least one of the pixel drive fields of the one or more of the array of pixels to compensate for the effect on the plurality of optical states independently of the pixel drive fields of other pixels in the array of pixels.

26. The method of claim 25, wherein adjusting the pixel drive fields includes selecting a pixel drive voltage, by the one or more of the array of pixels, based at least in part on the effect on the plurality of optical states of the temporal DC offsets.
